(19) United States
(12) Patent Application Publication
(10) Pub. No.: US 2016/0004655 A1
(43) Pub. Date: Jan. 7, 2016

(54) COMPUTING SYSTEM AND OPERATING METHOD OF THE SAME

(71) Applicant: SAMSUNG ELECTRONICS CO., LTD., SUWON-SI (KR)

(72) Inventors: YOUNG-KWANG YOO, YONGIN-SI (KR); JIN-HYEOK CHOI, YONGIN-SI (KR); SUN-YOUNG LIM, HWASEONG-SI (KR); YOUNG-JIN CHO, SEOUL (KR)

(21) Appl. No.: 14/791,282

(22) Filed: Jul. 3, 2015

(30) Foreign Application Priority Data
Jul. 4, 2014 (KR) 10-2014-0083900

(51) Int. Cl. G06F 13/32; G06F 12/10; G06F 13/42; G06F 12/06

(52) U.S. Cl. CPC G06F 13/32; G06F 12/0638; G06F 12/1081; G06F 13/4282; G06F 2212/205; G06F 2212/2532

(57) ABSTRACT

A computing system includes a first unified module including a first storage device and a second storage device that are different from each other, and a unified module interface configured to provide a direct memory access (DMA) request signal to control a first DMA with respect to the first storage device and to perform a second DMA on the second storage device. An application processor is configured to receive the DMA request signal from the unified module interface, and provide a DMA request response signal to the unified module interface and control the second DMA with respect to the second storage device.

### CROSS-REFERENCE TO RELATED APPLICATIONS

This application claims the benefit of Korean Patent Application No. 10-2014-0083900, filed on Jul. 4, 2014, in the Korean Intellectual Property Office, the disclosure of which is incorporated herein in its entirety by reference.

### BACKGROUND

The inventive concept relates to a computing system and an operating method of the computing system, and more particularly, to a computing system enabled for direct memory access (DMA) and an operating method of the computing system.

In the related art, according to a request from an internal or external block, e.g., an input/output (I/O) device, a DMA controller transmits data from an internal buffer of the requesting block to a set memory, or transmits data from a memory to the internal buffer of the requesting block. The internal buffer of the requesting block may be configured as a First In, First Out (FIFO) buffer so as to store therein a plurality of pieces of data. If the FIFO buffer stores enough data to be transmitted to the memory, or is empty and thus is capable of fetching data from the memory and storing the data, the requesting block requests the DMA controller for data transmission.

The DMA is repeatedly performed until the DMA controller completely transmits a preset amount of data that is set in the DMA controller. When the preset amount of data is completely transmitted by the DMA controller, the DMA controller generates an interrupt and thus notifies a central processing unit (CPU) or a micro-controller unit (MCU) that the transmission of the preset amount of data has been performed. After the CPU receives the interrupt, the CPU determines whether to further transmit data to the DMA controller or to perform other operations that sequentially occur, and then performs prediction.

### SUMMARY

According to an aspect of the inventive concept, there is provided a computing system including a first unified module comprising a first storage device and a second storage device that are different from each other, and a unified module interface that provides a direct memory access (DMA) request signal so as to control first DMA with respect to the first storage device and to perform second DMA on the second storage device. An application processor is for receiving the DMA request signal from the unified module interface, and providing a DMA request response signal to the unified module interface and controlling the second DMA with respect to the second storage device.

The first storage device may include at least one non-volatile storage device, and the second storage device may include at least one volatile storage device.

The unified module interface may include: a DMA engine that provides a communication protocol between the application processor and the unified module interface; a first storage controller that sets information of the communication protocol and controls the first storage device, when the second DMA with respect to the second storage device is requested; and a buffer to which data is loaded from the first storage device or the second storage device.

When the first DMA or the second DMA is performed, the DMA engine may provide DMA data information to the unified module interface or the application processor, wherein the DMA data information includes a source address, a destination address, a DMA data length, and DMA data control information about the data.

When the first DMA and the second DMA are completed, the DMA engine may generate an interrupt signal for notifying the application processor about the completion of the first DMA and the second DMA, and may provide the interrupt signal to the application processor, and in response to the interrupt signal, a central processing unit (CPU) of the application processor may use an on-chip bus of the application processor.

The first storage controller may generate and may provide the DMA request signal to the application processor so as to perform the second DMA.

The computing system may further include a second unified module, and in response to a DMA request signal from the second unified module, the application processor may control the second DMA with respect to the second storage device of the first unified module.

The application processor may include a DMA logic that receives the DMA request signal, provides, in response to the DMA request signal, a DMA request response signal to the unified module interface, controls the second DMA, and controls at least one of the first storage device and the second storage device, and a memory controller that provides the 1st unified module with a control signal related to the second DMA.

In the second DMA, the application processor, in response to the DMA request signal, may control the second storage device and may transfer data stored in the second storage device to the unified module interface, and in the first DMA, the unified module interface may control the first storage device and thus may transfer the data, which has been transferred from the second storage device to the unified module interface, to the first storage device.

In the first DMA, the unified module interface may control the first storage device and thus may transfer data stored in the first storage device to the unified module interface, and in the second DMA, in response to the DMA request signal, the application processor may control the second storage device and thus may transfer the data, which has been transferred from the first storage device to the unified module interface, to the second storage device.

According to another aspect of the inventive concept, there is provided an operating method of a computing system configured of an application processor including a central processing unit (CPU), and a unified module including a first storage device and a second storage device that are different from each other, and a unified module interface, the operating method including operations of performing, by a unified module interface, first direct memory access (DMA) on the first storage device; when second DMA with respect to the second storage device is requested, providing, by the unified module interface, a DMA request signal to the application processor; in response to the DMA request signal, providing, by the application processor, a DMA request response signal to the unified module interface; and performing, by the application processor, the second DMA on the second storage device.

The first storage device may include at least one non-volatile storage device, and the second storage device may include at least one volatile storage device.

The operation of performing the second DMA may include operations of controlling, by the application processor, the second storage device and transferring data stored in the second storage device to the unified module interface, and the operation of performing the first DMA may include an operation of controlling, by the application processor, the first storage device and transferring the data, which has been transferred from the second storage device to the unified module interface, to the first storage device.

The operation of performing the first DMA may include operations of controlling, by the application processor, the first storage device and thus transferring data stored in the first storage device to the unified module interface, and the operation of performing the first DMA may include an operation of controlling, by the application processor, the second storage device and transferring the data, which has been transferred from the first storage device to the unified module interface, to the second storage device.

When the first DMA and the second DMA are completed, the operating method may further include operations of generating an interrupt signal for notifying the application processor about the completion of the first DMA and the second DMA, and providing the interrupt signal to the application processor.

### BRIEF DESCRIPTION OF THE DRAWINGS

Exemplary embodiments of the inventive concept will be more clearly understood from the following detailed description taken in conjunction with the accompanying drawings in which:

FIG. 1 is a block diagram of a computing system according to an embodiment of the inventive concept;

FIG. 2 is a block diagram of a unified module interface, according to an embodiment of the inventive concept;

FIG. 3 is a block diagram of a 1st storage controller, according to an embodiment of the inventive concept;

FIG. 4 is a block diagram of a direct memory access (DMA) engine, according to an embodiment of the inventive concept;

FIGS. 5A and 5B illustrate formats of a communication protocol unit and a DMA data format register that are included in the DMA engine;

FIG. 5C illustrates data flow during a first DMA and a second DMA;

FIG. 6 is a block diagram of an application processor, according to an embodiment of the inventive concept;

FIG. 7 is a block diagram of a DMA logic, according to an embodiment of the inventive concept;

FIG. 8 is a block diagram of the computing system for first DMA and second DMA, according to an embodiment of the inventive concept;

FIG. 9 is a block diagram of the computing system that performs first DMA and second DMA, according to another embodiment of the inventive concept;

FIG. 10 is a flowchart of an operating method of the computing system that performs first DMA and second DMA, according to an embodiment of the inventive concept;

FIGS. 11 and 12 are flowcharts of the first DMA and the second DMA of FIG. 10; and

FIG. 13 illustrates a network system including a computing system that includes a unified module, according to an embodiment of the inventive concept.

### DETAILED DESCRIPTION OF THE EMBODIMENTS

The inventive concept will now be described more fully with reference to the accompanying drawings, in which exemplary embodiments of the inventive concept are shown. The inventive concept may, however, be embodied in many different forms, and should not be construed as being limited to the embodiments set forth herein; rather, these embodiments are provided so that this disclosure will be thorough and complete, and will fully convey the concept of the inventive concept to those of ordinary skill in the art. Thus, the inventive concept may include all revisions, equivalents, or substitutions which are included in the concept and the technical scope related to the invention. Like reference numerals in the drawings denote like elements. In the drawings, the dimension of structures may be exaggerated for clarity.

Furthermore, all examples and conditional language recited herein are to be construed as being without limitation to such specifically recited examples and conditions. Throughout the specification, a singular form may include plural forms, unless there is a particular description contrary thereto. Also, terms such as “comprise” or “comprising” are used to specify existence of a recited form, a number, a process, an operation, a component, and/or groups thereof, not excluding the existence of one or more other recited forms, one or more other numbers, one or more other processes, one or more other operations, one or more other components and/or groups thereof. Throughout the specification, while terms “first” and “second” are used to describe various components, it is obvious that the components are not limited to the terms “first” and “second”. The terms “first” and “second” are used only to distinguish between each component.

Unless expressly described otherwise, all terms including descriptive or technical terms which are used herein should be construed as having meanings that are obvious to one of ordinary skill in the art. Also, terms that are defined in a general dictionary and that are used in the following description should be construed as having meanings that are equivalent to meanings used in the related description, and unless expressly described otherwise herein, the terms should not be construed as being ideal or excessively formal. Expressions such as “at least one of,” when preceding a list of elements, modify the entire list of elements and do not modify the individual elements of the list.

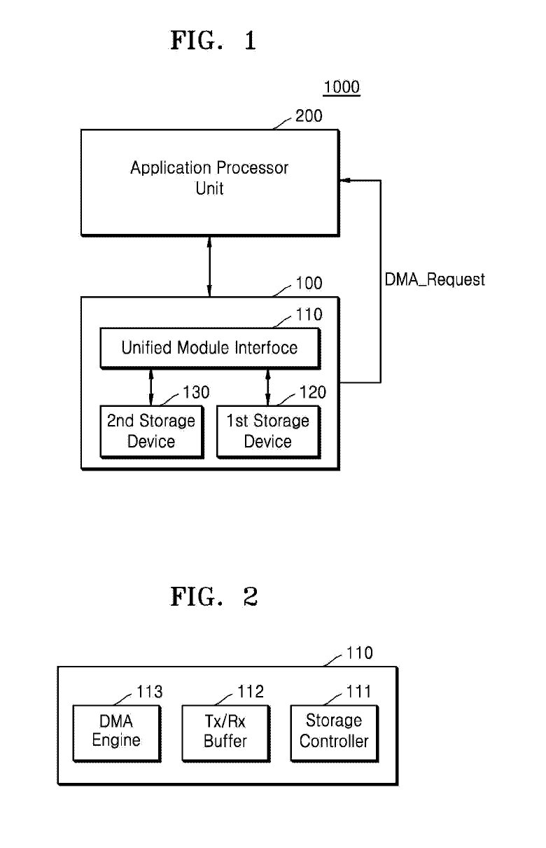

FIG. 1 is a block diagram of a computing system 1000 according to an embodiment of the inventive concept. Referring to FIG. 1, the computing system 1000 may include a 1^{st} unified module 100 and an application processor 200. The 1^{st} unified module 100 may include a 1^{st} storage device 120, a 2^{nd} storage device 130, and a unified module interface 110. For example, the 1 ^{st} storage device 120 may be one of various devices for performing various functions that are embodied via semiconductor processes. In the present embodiment, the 1^{st} storage device 120 may be a non-volatile storage device such as a hard disk drive (HDD) or a solid state drive (SSD), and the 2^{nd} storage device 130 may be a volatile storage device. However, the 2^{nd} storage device 130 may be a non-volatile storage device such as a magnetic random access memory (MRAM). Hereinafter, one or more embodiments of the inventive concept will now be described, assuming that the 2^{nd} storage device 130 is a volatile storage device and the 1^{st} storage device 120 is a non-volatile storage device. In an embodiment, the computing system 1000 may further include a plurality of storage devices as well as the 1^{st} and 2^{nd} storage devices 120 and 130.

A first DMA and a second DMA mean a first direct memory access and a second direct memory access, respectively, and due to the first and second DMAs, rapid data transmission is enabled between the 1^{st} storage device 120 and the 2^{nd} storage device 130. The unified module interface 110 may provide various control signals to the 1^{st} storage device 120 and thus may control operations of the 1^{st} storage device 120. For example, the unified module interface 110 may provide a command CMD, an address ADDRESS, a clock signal CLK, and a data signal DATA to the 1^{st} storage device 120 and thus may access a cell array of the 1^{st} storage device 120. Furthermore, the unified module interface 110 may control the first DMA.

The application processor 200 may be connected to the 1^{st} unified module 100 and the 1^{st} storage device 120, may provide control signals, and thus may control operations of devices. For example, the application processor 200 may provide a control signal in response to a command from a central processing unit (CPU) in the application processor 200 to the 1^{st} unified module 100 via a memory controller (not shown) in the application processor 200. Also, the memory controller may provide a command CMD, an address ADDRESS, a clock signal CLK, and a data signal DATA to the 2^{nd} storage device 130 and thus may access a cell array of the 2^{nd} storage device 130. Furthermore, the application processor 200 may control the second DMA. Based on a communication protocol between the unified module interface 110 and the application processor 200, the unified module interface 110 may provide a DMA request signal DMA_Request to the application processor 200, and in response to the request, the application processor 200 may perform the second DMA.

In the present embodiment, the first DMA may include at least one of preparing for providing the DMA request signal DMA_Request to the application processor 200, transferring data stored in the 1^{st} storage device 120 to the unified module interface 110, and transferring the data that was transferred to the unified module interface 110 to the 1^{st} storage device 120. The second DMA may include at least one of transferring data stored in the 2^{nd} storage device 130 to the unified module interface 110, and transferring the data that was transferred to the unified module interface 110 to the 2^{nd} storage device 130. The first DMA and the second DMA will be described in detail at a later time.

FIG. 2 is a block diagram of the unified module interface 110, according to an embodiment of the inventive concept. Referring to FIG. 2, the unified module interface 110 may include a Tx/Rx buffer 112, a 1^{st} storage controller 111, and a DMA engine 113. The Tx/Rx buffer 112 may temporarily store data for data transfer between the 1^{st} storage device 120 and the 2^{nd} storage device 130, or may be arranged to improve transfer efficiency, in consideration of a transfer speed difference between the 1^{st} storage device 120 and the 2nd storage device 130. The 1^{st} storage controller 111 may set communication protocol information and may control the first DMA. In the present embodiment, the 1^{st} storage controller 111 may provide various control signals to the 1^{st} storage device 120 and thus may access data stored in the 1^{st} storage device 120 or may transfer the accessed data to the Tx/Rx buffer 112. Also, the 1^{st} storage controller 111 may transfer data stored in the Tx/Rx buffer 112 to the ^{st} storage device 120. Also, in order to allow the application processor 200 to perform the second DMA, the 1^{st} storage controller 111 may provide the DMA request signal DMA_Request to the application processor 200. Furthermore, the 1^{st} storage controller 111 may prepare for providing the DMA request signal DMA_Request. Detailed descriptions about the preparation will be provided below. The DMA engine 113 may provide the communication protocol information that is the basis of communication between the application processor 200 and the unified module interface 110, and information about data that is a target object of the first DMA and the second DMA.

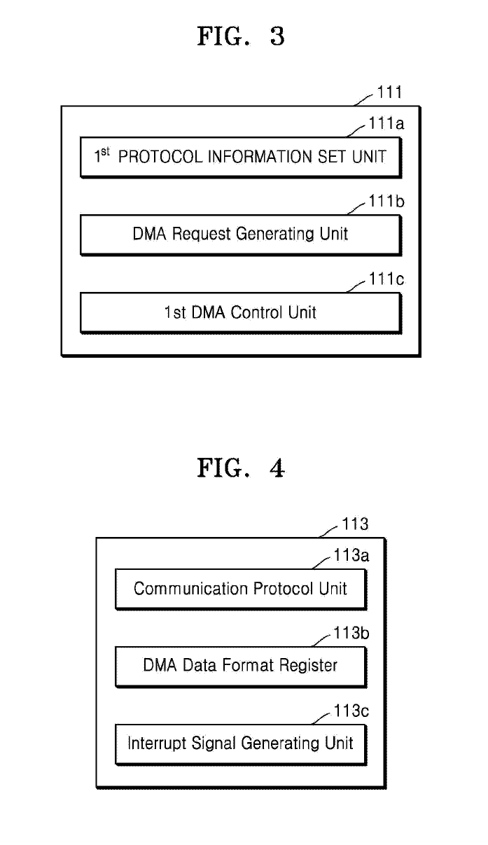

FIG. 3 is a block diagram of the 1^{st} storage controller 111, according to an embodiment of the inventive concept. Referring to FIG. 3, the 1^{st} storage controller 111 may include a 1^{st} protocol information set unit 111a, a DMA request generating unit 111b, and a 1^{st} DMA control unit 111c. The 1^{st} protocol information set unit 111a may set the communication protocol information in the DMA engine 113, so as to provide the DMA request signal DMA_Request to the application processor 200 which allows the application processor 200 to perform the second DMA. The DMA request generating unit 111b may generate the DMA request signal DMA_Request, based on the set communication protocol information, and may provide the DMA request signal DMA_Request to the application processor 200. In another embodiment, the DMA engine 113 may include the DMA request generating unit 111b and may provide the DMA request signal DMA_Request to the application processor 200. The 1^{st} DMA control unit 111c may control the first DMA related to the 1^{st} storage device 120. For example, the 1^{st} DMA control unit 111c may transfer data stored in the 1^{st} storage device 120 to the Tx/Rx buffer 112 or may transfer, to the 1^{st} storage device 120, data that was stored in the 2^{nd} storage device 130 and was then transferred from the 2^{nd} storage device 130 to the Tx/Rx buffer 112. In another embodiment, the 1^{st} protocol information set unit 111a and the 1^{st} DMA control unit 111c may be configured as one logic. In the present embodiment, a DMA data error checking and correction (ECC) unit that corrects an error of DMA-related data may be provided.

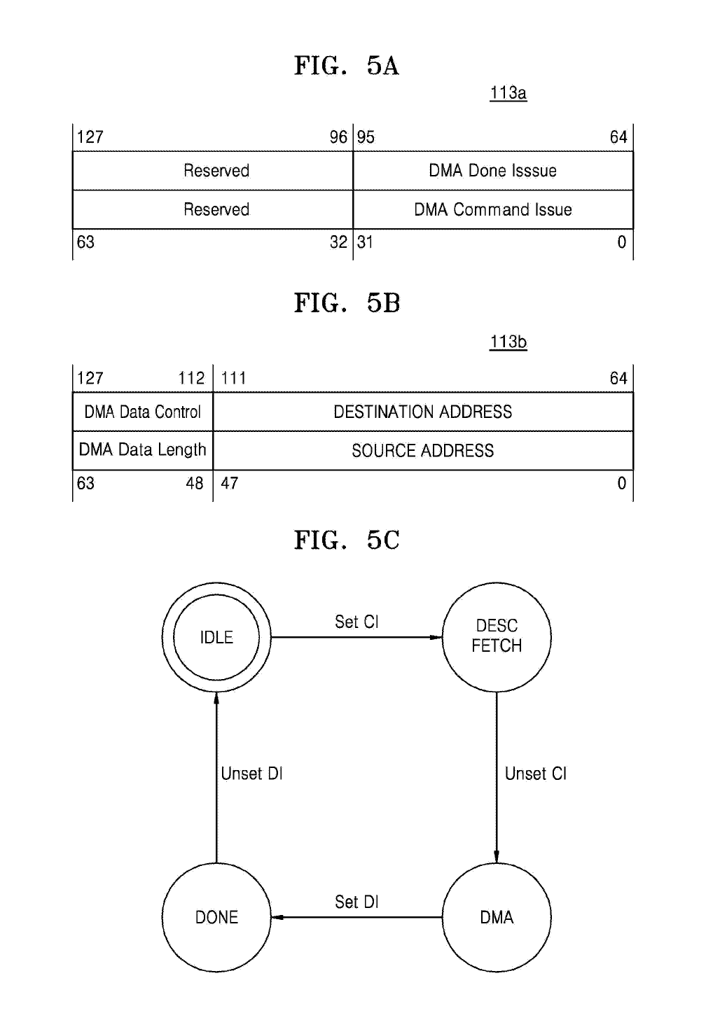

FIG. 4 is a block diagram of the DMA engine 113, according to an embodiment of the inventive concept. FIGS. 5A and 5B illustrate formats of a communication protocol unit 113a and a DMA data format register 113b that are included in the DMA engine 113. FIG. 5C illustrates data flow during the first DMA and the second DMA.

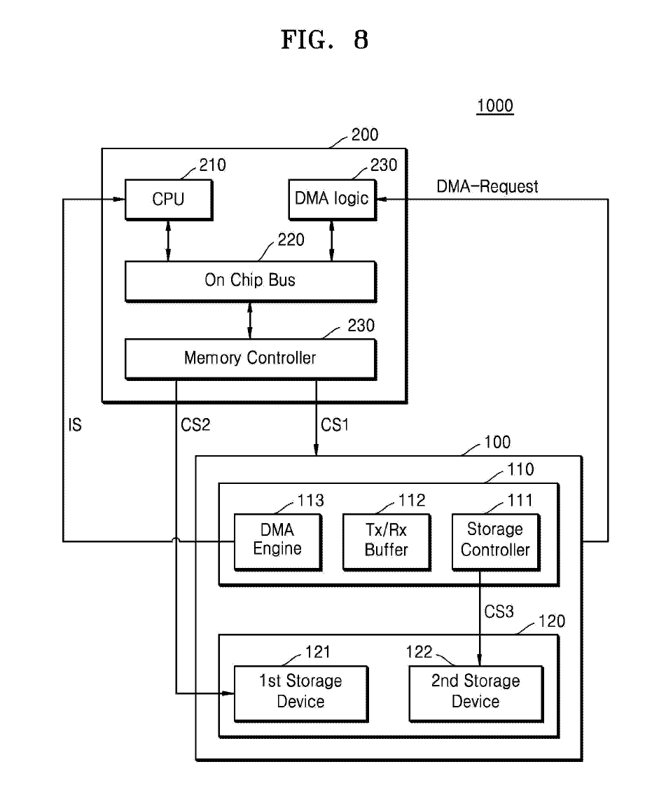

Referring to FIG. 4, the DMA engine 113 may include the communication protocol unit 113a, the DMA data format register 113b, and an interrupt signal generating unit 113c. The communication protocol unit 113a may have DMA Command issue information and DMA Done issue information. The unified module interface 110 of FIG. 8 may recognize, by referring to the DMA Command issue information, that the DMA logic 230 has completed receiving the DMA request signal DMA_Request, and the 1^{st} storage controller 111 of FIG. 8 may provide, by referring to the DMA Done issue information, a first DMA control signal CS3 for transmitting data to the 1^{st} storage device 120, wherein the data has been transmitted to the Tx/Rx buffer 112. The DMA Command issue information and the DMA Done issue information of FIG. 5A may be set as 32 bits. However, the DMA Command issue information and the DMA Done issue information of FIG. 5A are not limited to 32 bits, and in another embodiment, the DMA Command issue information and the DMA Done issue information of FIG. 5A may be variously set. Each bit indicates each DMA channel that performs the first DMA and the second DMA. Each DMA channel may be used in data transfer between the 1^{st} storage device 120 and the 2^{nd} storage device 130 by using the first DMA and the second DMA. A bit of the DMA Command issue information may be set from 0 to 1 by the 1^{st} storage controller 112, which means that data that is a target object of the first DMA and the second DMA is ready for transfer by using a DMA channel that corresponds to the bit. The application processor 200 may set the bit of the DMA Command issue information from 1 to 0. When the application processor 200 completes the second DMA, a bit of the DMA Done issue information may be set from 0 to 1, and after a predetermined period of time, the DMA engine 113 may set the bit of the DMA Done issue information from 1 to 0.

The DMA data format register 113b may store DMA Data Information shown in FIG. 5B. The application processor 200 or the 1^{st} storage controller 111 may control the first DMA and the second DMA by referring to the DMA Data Information stored in the DMA data format register 113b. The DMA Data Information may include a source address, a destination address, a DMA data length, and DMA data control information that are related to the data. The source address may indicate an address value of a position where the data is stored, and the destination address may indicate an address value of a position where the data is to be transferred. Also, the DMA data length may indicate a size of the data to be transferred in units of bytes, and the DMA data control information may be set as 00 when data stored in the 1^{st} storage device 120 is transferred to the 2^{nd} storage device 130, and may be set as 01 when data stored in the 2^{nd} storage device 130 is transferred to the 1^{st} storage device 120, thus indicating a direction of the data transfer using the first DMA and the second DMA. The number of pieces of the DMA Command issue information and the DMA Done issue information may match the number of the DMA channels requested by the application processor 200.

After the first DMA and the second DMA are completed, the interrupt signal generating unit 113c of FIG. 4 may generate an interrupt signal for notifying the application processor 200 about completion of the first DMA and the second DMA. However, a location of the interrupt signal generating unit 113c is not limited in the DMA engine 113 and thus the interrupt signal generating unit 113c may be included anywhere in the unified module interface 110.

FIG. 5C illustrates the data flow during the first DMA and the second DMA. In a case where data is transferred from the 2^{nd} storage device 130 that is the volatile storage device to the 1^{st} storage device 120 that is the non-volatile storage device, first, when the data stored in the 2^{nd} storage device 130 is ready for transfer in an IDLE state, a bit of DMA Command issue information of the communication protocol provided by the DMA engine 113 in the unified module interface 110 may be set from 0 to 1, wherein the bit indicates a DMA channel to transfer the data. However, in another embodiment, the 1^{st} storage controller 111 may set the bit of the DMA Command issue information from 0 to 1. Next, the 1^{st} storage controller 111 of the unified module interface 110 may check that the bit of the DMA Command issue information is set as 1 and may generate and provide a DMA request signal DMA_Request to the application processor 200. In response to the request, the application processor 200 may set the bit of the DMA Command issue information from 1 to 0, may refer to the DMA Command issue information and thus may transfer, to the unified module interface 110, the data stored in the 2^{nd} storage device 130 that is the volatile storage device.

In the present embodiment, the application processor 200 may transfer the data to the Tx/Rx buffer 112 in the unified module interface 110. After the application processor 200 completes the transfer of the data, the application processor 200 may set a bit of DMA Done issue information of the communication protocol from 0 to 1, wherein the bit indicates the DMA channel that has transferred the data. Then, the 1^{st} storage controller 111 may refer to the DMA Done issue information and thus may transfer the data of the Tx/Rx buffer 112 to the 1^{st} storage device 120 that is the non-volatile storage device. After the transfer is completed, the DMA engine 113 may set the bit of the DMA Done issue information from 1 to 0 and thus enter the IDLE state.

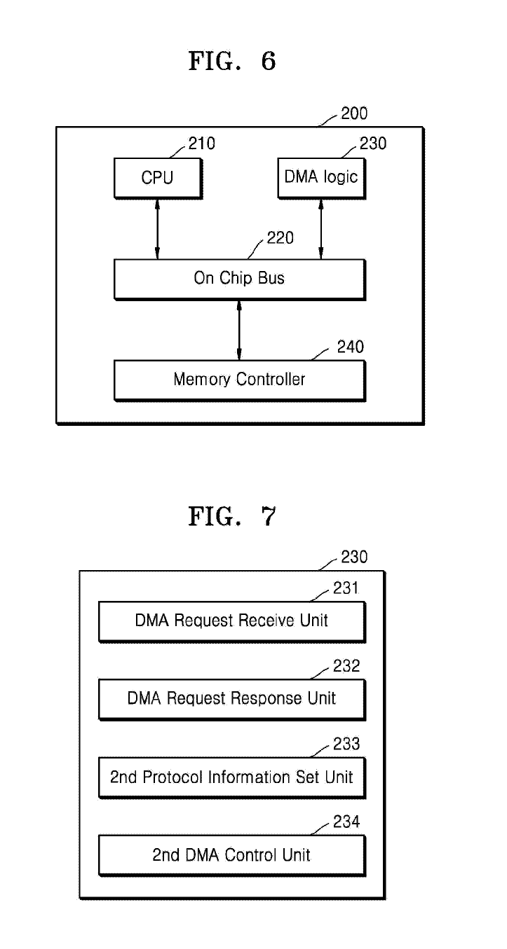

FIG. 6 is a block diagram of the application processor 200, according to an embodiment of the inventive concept. Referring to FIG. 6, the application processor 200 may include a CPU 210, a DMA logic 230, a memory controller 240, and an on-chip bus 220. The CPU 210 and the DMA logic 230 may exchange signals and data via the on-chip bus 220. The memory controller 240 may be connected to the unified module interface 110 of FIG. 8 to be described later and thus may provide a control signal from the CPU 210 or the DMA logic 230 to the unified module interface 110. Also, the memory controller 240 may be connected to the 2^{nd} storage device 130 that is the volatile storage device and thus may access data stored in the 2^{nd} storage device 130, and for example, the memory controller 240 may write data to or read data from the 2^{nd} storage device 130, based on the control signal from the CPU 210 or the DMA logic 230, and may control the 2^{nd} storage device 130 to transfer stored data to the unified module interface 110.

The DMA logic 230 may receive a DMA request signal DMA_Request provided from the unified module interface 110. In response to the request, the DMA logic 230 may generate and provide a DMA request response signal DMA_Request_Response to the unified module interface 110. In the present embodiment, the DMA logic 230 may provide the DMA request response signal DMA_Request_Response to the DMA engine 113 in the unified module interface 110. As described above, the receipt of and response to the DMA request signal DMA_Request may be performed based on a communication protocol of the DMA engine 113. In the present embodiment, the DMA engine 113 may receive the DMA request response signal DMA_Request_Response and thus may set a bit of DMA Command issue information of the communication protocol of the DMA engine 113 from 1 to 0. The unified module interface 110 may refer to the DMA Command issue information and thus may recognize that the DMA logic 230 has received the DMA request signal DMA_Request. Also, after the DMA logic 230 receives the DMA request signal DMA_Request, the DMA logic 230 may control second DMA. In the present embodiment, the DMA logic 230 may refer to the communication protocol of the DMA engine 113 and may transfer the data stored in the 2^{nd} storage device 130 to the Tx/Rx buffer 112 in the unified module interface 110 or may transfer data, which was transferred from the 1^{st} storage device 120 to the Tx/Rx buffer 112, to the 2nd storage device 130 via the memory controller 240.

FIG. 7 is a block diagram of the DMA logic 230, according to an embodiment of the inventive concept. Referring to FIG. 7, the DMA logic 230 may include a DMA request receive unit 231, a DMA request response unit 232, a 2^{nd} protocol information set unit 233, and a 2^{nd} DMA control unit 234. The DMA request receive unit 231 may receive a DMA request signal DMA_Request from the unified module interface 110. In response to the DMA request signal DMA_Request, the DMA request response unit 232 may provide a DMA request response signal DMA_Request_Response to the unified module interface 110. The 2^{nd} protocol information set unit 233 may set DMA Command issue information and DMA Done issue information of a communication protocol that is provided by the DMA engine 113.

The 2^{nd} DMA control unit 234 may control data stored in the 2^{nd} storage device 130 to be transferred to the unified module interface 110 or may control data, which was transferred to the unified module interface 110, to be transferred to the 2^{nd} storage device 130. In the present embodiment, the DMA logic 230 may further include a Read/Write command queue unit (not shown) that stores a plurality of read/write commands and allows read and write operations to be sequentially performed.

FIG. 8 is a block diagram of the computing system 1000 for a first DMA and a second DMA, according to an embodiment of the inventive concept.

Referring to FIG. 8, the computing system 1000 may include the 1^{st} unified module 100 and the application processor 200. The 1^{st} unified module 100 may include the unified module interface 110, the 1^{st} storage device 120, and the 2^{nd} storage device 130. The application processor 200 may include the CPU 210, the DMA logic 230, the memory controller 240, and the on-chip bus 220 that connects the aforementioned components. The CPU 210 may command the first DMA and the second DMA, and the first DMA and the second DMA may be provided to the unified module interface 110 via the memory controller 240.

If data is transferred from the 2^{nd} storage device 130 to the 1^{st} storage device 120, the 1^{st} storage controller 111 may set a bit of DMA Command issue information of the communication protocol of the DMA engine 113 from 0 to 1, wherein the bit indicates a DMA channel to transfer the data. Afterward, the 1^{st} storage controller 111 may refer to the DMA Command issue information and thus may provide a DMA request signal DMA_Request to the DMA logic 230. The DMA logic 230 may provide a DMA request response signal DMA_Request_Response to the DMA engine 113. As described above, the request for and response to the DMA request signal DMA_Request may be performed based on the communication protocol provided by the DMA engine 113. Since the DMA logic 230 provides the DMA request response signal DMA_Request_Response, the bit of the DMA Command issue information of the communication protocol of the DMA engine 113 may be set from 1 to 0. The DMA logic 230 may provide a second DMA control signal CS2 via the memory controller 240 and thus may transfer data stored in the 2^{nd} storage device 130 to the Tx/Rx buffer 112. DMA data information about the stored data to be transferred may be stored in a DMA data information register of the DMA engine 113, and when the memory controller 240 transfers the data, the memory controller 240 may refer to the DMA data information of the DMA data information register. In the present embodiment, the data may be transferred in a manner that the memory controller 240 provides a command of reading the data stored in the 2^{nd} storage device 130 and then writes the read data to the Tx/Rx buffer 112. Accordingly, the data may be transferred to the Tx/Rx buffer 112 and thus may be stored in the Tx/Rx buffer 112. After the DMA logic 230 completes the transfer of the data, the DMA logic 230 may set a bit of DMA Done issue information of the communication protocol of the DMA engine 113 from 0 to 1, wherein the bit indicates a DMA channel that has transferred the data, and the 1^{st} storage controller 111 that refers to the DMA Done issue information may provide a first DMA control signal CS3 for transferring the data of the Tx/Rx buffer 112 to the 1^{st} storage device 120 and thus may transfer the data to the 1^{st} storage device 120.

If data is transferred from the 1^{st} storage device 120 to the 2^{nd} storage device 130, the 1st storage controller 111 may set a bit of the DMA Command issue information of the communication protocol of the DMA engine 113 from 0 to 1, wherein the bit indicates a DMA channel to transfer the data. Afterward, the 1^{st} storage controller 111 may provide the first DMA control signal CS3 and thus may transfer the data stored in the 1^{st} storage device 120 to the Tx/Rx buffer 112. DMA data information about the stored data to be transferred may be stored in the DMA data information register of the DMA engine 113, and when the 1^{st} storage controller 111 transfers the data, the 1^{st} storage controller 111 may refer to the DMA data information of the DMA data information register. When the transfer is completed, the 1^{st} storage controller 111 may refer to the DMA Command issue information and thus may provide a DMA request signal DMA_Request to the DMA logic 230. The DMA logic 230 may provide a DMA request response signal DMA_Request_Response to the DMA engine 113.

As described above, the request for and response to the DMA request signal DMA_Request may be performed based on the communication protocol provided by the DMA engine 113. Since the DMA logic 230 provides the DMA request response signal DMA_Request_Response, the bit of the DMA Command issue information of the communication protocol of the DMA engine 113 may be set from 1 to 0. The DMA logic 230 may provide a second DMA control signal CS1 via the memory controller 240 and thus may transfer the data of the Tx/Rx buffer 112 to the 2^{nd} storage device 130. In the present embodiment, the data may be transferred in a manner that the memory controller 240 provides a command of reading the data that was transferred to the Tx/Rx buffer 112 and then writes the read data to the 2^{nd} storage device 130. After the DMA logic 230 completes the transfer of the data, the DMA logic 230 may set a bit of the DMA Done issue information from 0 to 1, wherein the bit indicates a DMA channel that has transferred the data. In the present embodiment, in order to allow the CPU 210 of the application processor 200 to recognize the completion of the first DMA and the second DAM and to use the on-chip bus 220, the DMA engine 113 may provide an interrupt signal IS to the CPU 210.

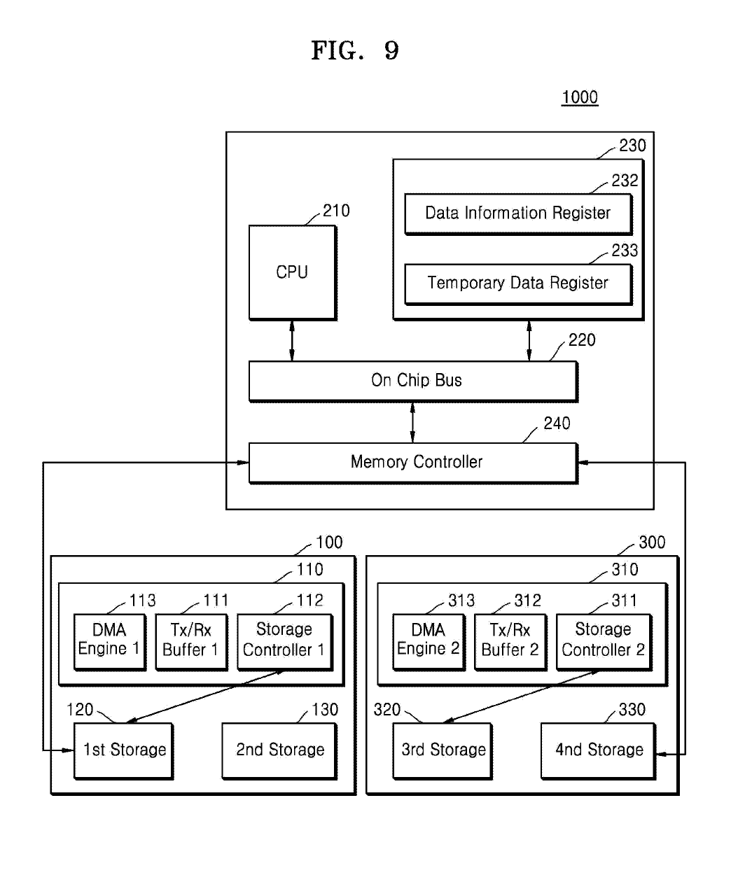

FIG. 9 is a block diagram of the computing system 1000 that performs a first DMA and a second DMA, according to another embodiment of the inventive concept. Unlike the embodiment of FIG. 8, the computing system 1000 of FIG. 9 may not perform data transfer within the 1^{st} unified module 100 but may perform data transfer between the 1^{st} unified module 100 and a 2^{nd} unified module 300. Referring to FIG. 9, unlike the DMA logic 230 of FIG. 8, the DMA logic 230 of FIG. 9 may further include a data information register 232 and a temporary data register 233.

In a case where data stored in the 2^{nd} unified module 300 is ready for transfer and then is completely transferred to a Tx/Rx buffer 2 312 via a first DMA, the 2nd unified module interface 310 may provide a DMA request signal DMA_Request to the DMA logic 230. In response to the request, the DMA logic 230 may temporarily store information about the data that has been transferred to the Tx/Rx buffer 2 312 in the data information register 232, and may temporarily store the transferred data in the temporary data register 233. The DMA logic 230 may refer to the data information register 232 and the temporary data register 233, and thus may control a second DMA for transferring data to the 1st unified module 100.

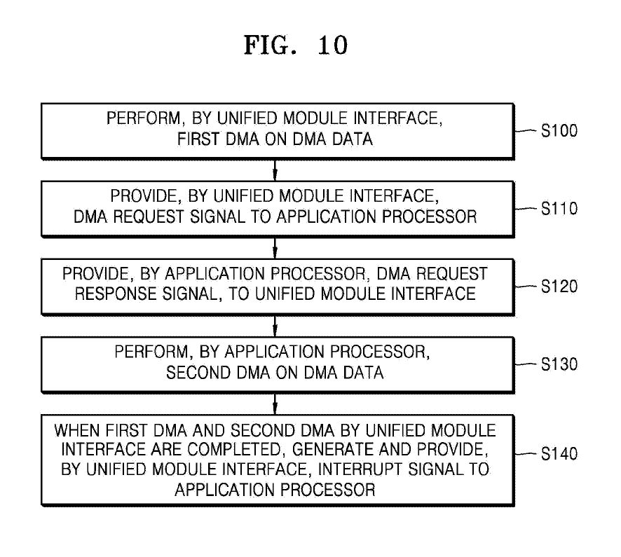

FIG. 10 is a flowchart of an operating method of the computing system 1000 that performs a first DMA and a second DMA, according to an embodiment of the inventive concept. Referring to FIG. 10, the unified module interface 110 performs the first DMA on DMA data that is stored in the 1^{st} storage device 120 or the 2^{nd} storage device 130 and is a target object of the first DMA and the second DMA (operation S100). Afterward, the unified module interface 110 provides a DMA request signal DMA_Request to the application processor 200 (operation S110). In response to the request, the application processor 200 provides a DMA request response signal DMA_Request_Response to the unified module interface 110 (operation S120). The application processor 200 performs the second DMA on the DMA data (operation S130). Furthermore, in the present embodiment, when the first DMA and the second DMA are completed, the unified module interface 110 may generate and provide the interrupt signal IS to the application processor 200 (operation S140). Detailed descriptions about each operation are as described above.

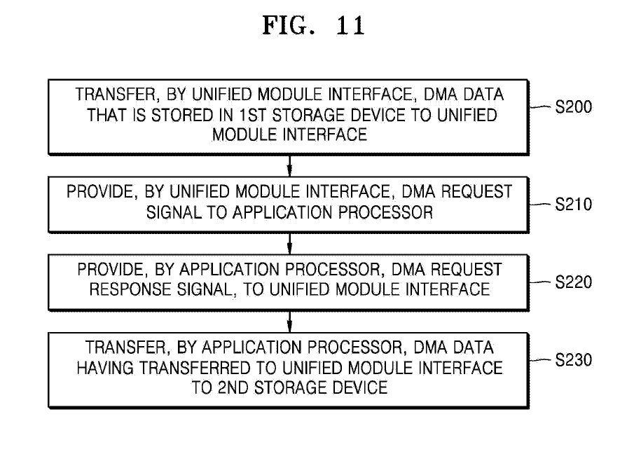

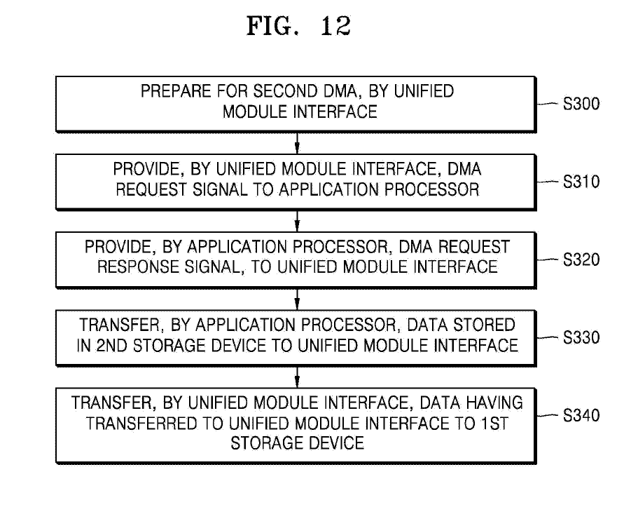

FIGS. 11 and 12 are flowcharts of the first DMA and the second DMA of FIG. 10. FIG. 11 is the flowchart of the first DMA and the second DMA when data that is stored in the 1^{st} storage device 120 is transferred to the 2^{nd} storage device 130. First, in the first DMA, the unified module interface 110 transfers DMA data that is stored in the 1^{st} storage device 120 to the unified module interface 110 (operation S200). Then, the unified module interface 110 provides a DMA request signal DMA_Request to the application processor 200 (operation S210). The application processor 200 provides a DMA request response signal DMA_Request_Response to the unified module interface 110 (operation S220). Afterward, the application processor 200 performs the second DMA by transferring the DMA data, which was transferred to the unified module interface 110, to the 2^{nd} storage device 130 (operation S230).

FIG. 12 is the flowchart of the first DMA and the second DMA when data that is stored in the 2^{nd} storage device 130 is transferred to the 1^{st} storage device 120. First, the unified module interface 110 prepares for the second DMA (operation S300). In operation S300, a bit of DMA Command issue information of a communication protocol provided by the DMA engine 113 in the unified module interface 110 may be set from 0 to 1, and operation 5300 may be included in the first DMA. The unified module interface 110 may provide a DMA request signal DMA_Request to the application processor 200 (operation S310). The application processor 200 may provide a DMA request response signal DMA_Request_Response to the unified module interface 110 (operation S320), and the application processor 200 may transfer the data stored in the 2^{nd} storage device 130 to the unified module interface 110 (operation S330). Operation S330 in which the data is transferred to the unified module interface 110 may correspond to the second DMA. Then, the unified module interface 110 may transfer the data that has been transferred to the unified module interface 110 to the 1^{st} storage device 120 (operation S340). Operation S340 in which the data is transferred to the 1^{st} storage device 120 may correspond to the first DMA.

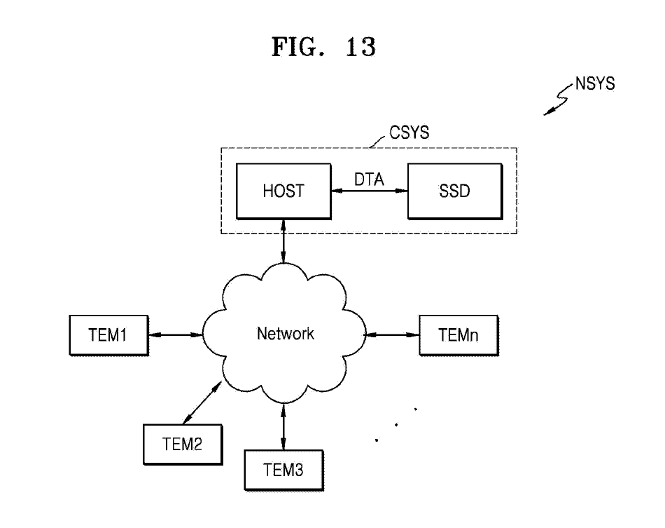

FIG. 13 illustrates a network system NSYS including a computing system CSYS that includes a unified module, according to an embodiment of the inventive concept. Referring to FIG. 13, the network system NSYS may include the computing system CSYS and a plurality of terminals TEM1 through TEMn that are connected via a network. In the present embodiment, the computing system CSYS may include a server (not shown) that processes requests from the plurality of terminals TEM1 through TEMn connected via the network, and the unified module that stores one or more pieces of data that corresponds to the requests from the plurality of terminals TEM1 through TEMn.

An application processor shown in FIG. 13 may correspond to the application processor 200 of FIG. 1. Also, the computing system CSYS of FIG. 13 may correspond to the computing system 1000 of FIG. 1. Also, when the application processor of FIG. 13 issues a data transfer command and a DMA command to the terminals TEM1 through TEMn included in the network, the aforementioned methods of FIG. 1 may be applied thereto.

While the inventive concept has been particularly shown and described with reference to exemplary embodiments thereof, it will be understood that various changes in form and details may be made therein without departing from the spirit and scope of the following claims.

What is claimed is:

1. A computing system comprising:
a first unified module comprising a first storage device and a second storage device that are different from each other, and a unified module interface configured to provide a direct memory access (DMA) request signal to control a first DMA with respect to the first storage device and to perform a second DMA with respect to the second storage device; and
an application processor configured to receive the DMA request signal from the unified module interface, and provide a DMA request response signal to the unified module interface and control the second DMA with respect to the second storage device.

2. The computing system of claim 1, wherein the first storage device comprises at least one non-volatile storage device, and the second storage device comprises at least one volatile storage device.

3. The computing system of claim 1, wherein the unified module interface comprises:
a DMA engine configured to provide a communication protocol between the application processor and the unified module interface;
a first storage controller configured to set information of a communication protocol and control the first storage device, when the second DMA with respect to the second storage device is requested; and
a buffer configured to load data from the first storage device or the second storage device.

4. The computing system of claim 3, wherein, when the first DMA or the second DMA is performed, the DMA engine is configured to provide DMA data information to at least one of the unified module interface and the application processor, wherein the DMA data information includes a source address, a destination address, a DMA data length, and DMA data control information about the data.

5. The computing system of claim 3, wherein, when the first DMA and the second DMA are completed, the DMA engine is configured to generate an interrupt signal for notifying the application processor about the completion of the first DMA and the second DMA and provide the interrupt signal to the application processor; and
wherein, in response to the interrupt signal, a central processing unit (CPU) of the application processor is configured to use an on-chip bus of the application processor.

6. The computing system of claim 3, wherein the first storage controller is configured to generate and provide the DMA request signal to the application processor to perform the second DMA.

7. The computing system of claim 1, further comprising a second unified module; and
wherein, in response to a DMA request signal from the second unified module, the application processor is configured to control the second DMA with respect to the second storage device of the first unified module.

8. The computing system of claim 1, wherein the application processor comprises a DMA logic configured to receive the DMA request signal, provide, in response to the DMA request signal, the DMA request response signal to the unified module interface, control the second DMA, and control at least one of the first storage device and the second storage device.

9. The computing system of claim 1, wherein, in the second DMA, the application processor, in response to the DMA request signal, is configured to control the second storage device and transfer data stored in the second storage device to the unified module interface; and
wherein, in the first DMA, the unified module interface is configured to control the first storage device and thus transfer the data, which has been transferred from the second storage device to the unified module interface, to the first storage device.

10. The computing system of claim 1, wherein, in the first DMA, the unified module interface is configured to control the first storage device and thus transfer data stored in the first storage device to the unified module interface; and
wherein, in the second DMA, in response to the DMA request signal, the application processor is configured to control the second storage device and thus transfer the data, which has been transferred from the first storage device to the unified module interface, to the second storage device.

11. An operating method of a computing system including an application processor comprising a central processing unit (CPU), and a unified module comprising a first storage device and a second storage device that are different from each other, and a unified module interface, the operating method comprising:
performing, by the unified module interface, a first direct memory access (DMA) on the first storage device;
when a second DMA with respect to the second storage device is requested, providing, by the unified module interface, a DMA request signal to the application processor;
in response to the DMA request signal, providing, by the application processor, a DMA request response signal to the unified module interface; and
performing, by the application processor, the second DMA on the second storage device.

12. The operating method of claim 11, wherein the first storage device comprises at least one non-volatile storage device, and the second storage device comprises at least one volatile storage device.

13. The operating method of claim 11, wherein the performing of the second DMA comprises controlling, by the application processor, the second storage device and transferring data stored in the second storage device to the unified module interface; and
wherein the performing of the first DMA comprises controlling, by the application processor, the first storage device and transferring the data, which has been transferred from the second storage device to the unified module interface, to the first storage device.

14. The operating method of claim 11, wherein the performing of the first DMA comprises controlling, by the application processor, the first storage device and thus transferring data stored in the first storage device to the unified module interface; and
wherein the performing of the first DMA comprises controlling, by the application processor, the second storage device and transferring the data, which has been transferred from the first storage device to the unified module interface, to the second storage device.

15. The operating method of claim 11, further comprising, when the first DMA and the second DMA are completed, generating an interrupt signal for notifying the application processor about the completion of the first DMA and the second DMA, and providing the interrupt signal to the application processor.
